(19) United States
(12) Patent Application Publication
(10) Pub. No.: US 2003/0163464 A1
(43) Pub. Date: Aug. 28, 2003

(54) Method and apparatus to validate a date input

(76) Inventor: Srividhya Gopalan, Union City, CA (US)

Correspondence Address: ROSENTHAL & OSHA L.L.P. / SUN, 1221 MCKINNEY, SUITE 2800, HOUSTON, TX, 77010, US

(21) Appl. No.: 10/071,110

(22) Filed: Feb. 8, 2002

(51) Int. Cl. G06F 17/30

(52) U.S. Cl. 707/6

(57) ABSTRACT

A technique for validating a date input using a date creating function of a particular software language is provided. The date validation technique compares a date value inputted by a user and a date generated by the particular software language, and if the comparison shows that the two dates are equivalent, then the user inputted date is deemed to be valid. Otherwise, if the two dates are not equivalent, then the user inputted date is deemed to be invalid.

### BACKGROUND OF INVENTION

A date includes a year, a month, and a day. The present concept of the duration of a year is based on the earth's motion around the sun. The time from one fixed point, such as a solstice or equinox, to the next is called a tropical year. Its length is currently 365.242190 days, but it varies. Around 1900 its length was 365.242196 days, and around 2100 it will be 365.242184 days.

The tropical year is defined as the mean interval between vernal equinoxes; it corresponds to the cycle of the seasons. The calendar year is linked to the tropical year as measured between two March equinoxes.

The concept of the duration of a month is based on the moon's motion around the earth, although this connection has been broken in the calendar commonly used now. The time from one new moon to the next is called a synodic month, and its length is currently 29.5305889 days, but it varies. Around 1900 its length was 29.5305886 days, and around 2100 it will be 29.5305891 days. Note that these numbers are averages.

The concept of the duration of a day is based on the length of time it takes the earth to make one complete revolution around its axis. This is equal to 24 hours, where each hour is 60 minutes in duration.

The actual length of a particular year may vary by several minutes due to the influence of the gravitational force from other planets. Similarly, the time between two new moons may vary by several hours due to a number of factors, including changes in the gravitational force from the sun and the moon's orbital inclination.

A calendar provides a set of rules to follow to ensure a temporal commonality. Numerous different calendars have been used over time, however three prominent calendar systems are the Gregorian calendar, the Islamic calendar, and the Jewish calendar.

The Gregorian calendar is based on the motion of the earth around the sun, while the months have no connection with the motion of the moon. On the other hand, the Islamic calendar is based on the motion of the moon, while the year has no connection with the motion of the earth around the sun. The Jewish calendar combines both, in that its years are linked to the motion of the earth around the sun, and its months are linked to the motion of the moon.

The calendar used throughout most of the world today is the Gregorian calendar. In the Gregorian calendar, the tropical year is approximated as 365 97/400 days=365.2425 days. Thus it takes approximately 3300 years for the tropical year to shift one day with respect to the Gregorian calendar. The approximation 365 97/400 is achieved by having 97 leap years every 400 years.

As the rules regarding the Gregorian calendar change, so does a validating system to determine the proper date.

Because the date is so vital to human understanding, almost every computer application has code to determine if a date inputted from a user is valid as to the rules of the Gregorian calendar, or whichever calendar system is used in that particular community. The validating code requires developers to write special code containing each rule of validation for each program.

One existing approach to validate a date involves using a series of queries. The following is an example of a series of possible queries performed if the rules of the Gregorian calendar are applied.

Is the day greater than zero and the month greater than zero? If no, invalid date; if yes, proceed.

Next, is the year within valid limits? If no, invalid date; if yes, proceed.

Next, is the month less than thirteen? If no, invalid date; if yes, proceed

Next, is the month one of one, three, five, seven, eight, ten, or twelve, and the day less than thirty-two? If yes, valid date and end evaluation; if no, proceed.

Next, is the month one of four, six, nine, or eleven, and the day less than thirty-one? If yes, valid date and end evaluation; if no, proceed.

Next, is the month two and the day less than twenty-nine? If yes, valid date and end evaluation; if no, proceed.

Next, is month two and date equal to twenty-nine and less than thirty? If no, invalid date and end evaluation; if yes, proceed.

Finally, is the year divisible by four? If yes, valid date and end evaluation; if no, invalid date and end evaluation.

In sum, the current approach to validating a date involves validating a date by applying the rules of the Gregorian calendar. This approach requires a clear understanding of complex date rules, e.g., leap year rules, and requires changes in implementation code if the Gregorian calendar rules change. Further, such an approach is vulnerable if certain date values are hard coded in the implementation, e.g., 9/9/99 or 12/31/99. Thus, there is a need for an approach to validate a date using a more simple and efficient technique.

### SUMMARY OF INVENTION

According to one aspect of the present invention, a method for validating a date comprises formatting a user inputted date to match requirements of a programming language; sending the formatted date as a parameter of a date format function of the programming language; generating a program language generated date; and comparing the user inputted date to the program language generated date.

According to another aspect, a method for validating a date comprises formatting a user inputted date to match requirements of a programming language; sending the formatted date as a parameter of a date format function of the programming language; generating a program language generated date; comparing the user inputted date to the program language generated date; outputting the manipulated date input to a variable; returning a Boolean value of true or false after comparing the output; sending an object after the comparison; and throwing an exception after the comparison.

According to another aspect, a computer system to validate a date comprises a processor; a memory; and software instructions stored in the memory for enabling the computer system under control of the processor, to perform: formatting a user inputted date to match requirements of a programming language; sending the formatted date as a parameter of a date format function of the programming language; generating a program language generated date; comparing the user inputted date to the program language generated date; outputting the manipulated date input to a variable; returning a Boolean value of true or false after comparing the output; sending an object after the comparison; and throwing an exception after the comparison.

According to another aspect, a date validation mechanism comprises means for formatting a user inputted date to match requirements of a programming language; means for sending the formatted date as a parameter of a date format function of the programming language; means for generating a program language generated date; means for comparing the user inputted date to the program language generated date; means for outputting the manipulated date input to a variable; and means for returning a Boolean value of true or false after comparing the output.

Other aspects and advantages of the invention will be apparent from the following description and the appended claims.

### BRIEF DESCRIPTION OF DRAWINGS

FIG. 1 illustrates a typical computer system connected to the Internet.

FIG. 2 illustrates a typical example of how a user-inputted date may be entered in a web-based application.

FIG. 3 illustrates an exemplary flow process of a date validation mechanism in accordance with an embodiment of the invention.

### DETAILED DESCRIPTION

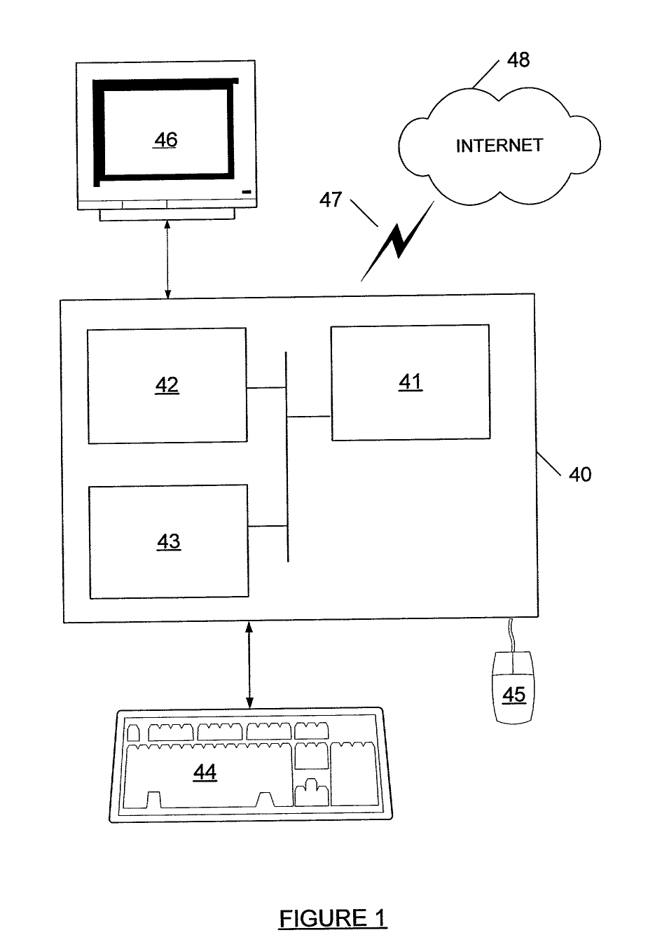

The present invention may be implemented on virtually any type computer regardless of the platform being used. For example, as shown in FIG. 1, a typical computer (40) includes a processor (41), a memory (42), a storage device (43), and numerous other elements and functionalities typical of computers known in the art. The computer (40) may also include input means, such as a keyboard (44) and a mouse (45), and an output device, such as a monitor (46). Those skilled in the art will appreciate that these input and output means may take other forms in an accessible environment. The computer (40) may be connected via a network connection (47) to a wide area network, such as Internet (48).

A date validation mechanism is an approach to validating a user-inputted date in a computer program. The date validation mechanism of the invention uses a date creation function of an underlying programming language with user-inputted dates as a parameter to obtain a valid date, and compares the numeric values of the obtained date with the user-inputted date. The underlying programming language supplies locale-specific date rules that are embedded into the program upon compilation.

In one or more embodiments of the present invention, a typical sequence of events involving date validation is described below. A user enters a date as part of a series of input fields on, e.g. a web page or other form. The date validation mechanism may be a Boolean function or a behavior of a class that is triggered by a user signified event. The user signified event includes clicking submit, pressing an enter button, pressing a tab button, or a variety of other data entry operations. The date validation mechanism manipulates the user-inputted date to a form recognized by a format date function of a particular programming language, such as COM, Java, C++, etc. A manipulated date is outputted to a variable, which is used as a parameter of the format date function of the programming language. The format date function operates upon the parameter and returns a program language generated date as output. The program language generated date is compared to the user entered date. If the comparison results in a match, a true Boolean value is returned by the date validation mechanism. Otherwise, if not a match, a false Boolean value is returned by the date validation mechanism. One skilled in the art can appreciate that the date validation mechanism may be implemented as a behavior of a class. If the comparison results in a match, an object is sent. Otherwise, if not a match, an exception is thrown.

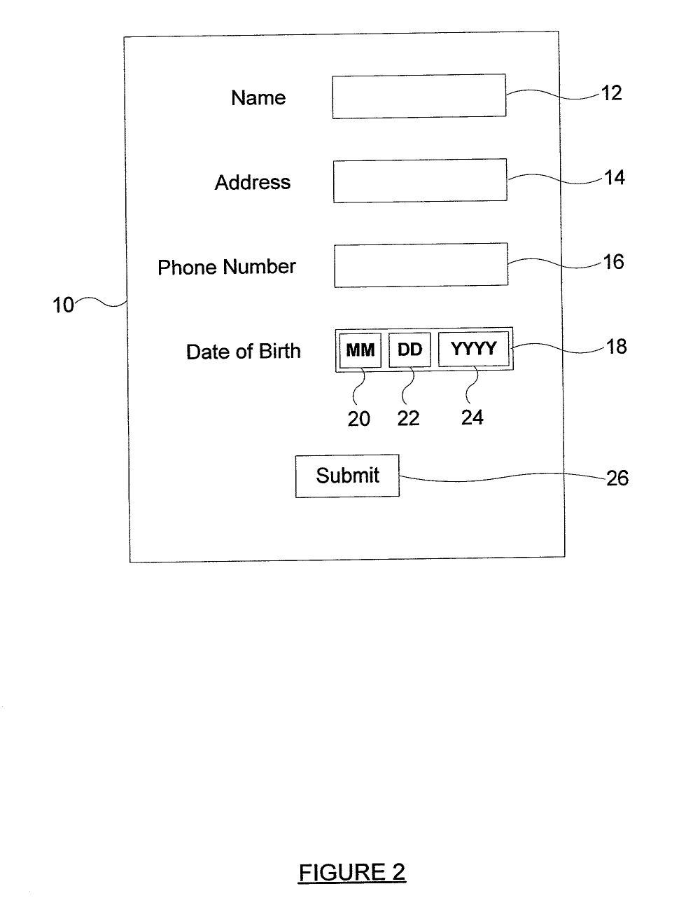

FIG. 2 illustrates a typical example of how a user-inputted date may be entered in a web-based application (10). The user may be asked to enter personal information into a name text-field box (12), an address text-field box (14), a phone number text-field box (16), and a date-of-birth text-field box (18). The date-of-birth text-field box may be separated into a month category (20), a day category (22), and a year category (24). Once this information has been entered into the text-field boxes, the user may need to click on a submission button (26) to send the data back to the computer program. Those skilled in the art can appreciate that a user of a computer program may input a date in a variety of different manners. For example, the user may enter the date by selecting from drop boxes containing text indicating the day, month, and year, as one contiguous string of numbers separated by a period (.), a dash (-), or a slash (/), etc.

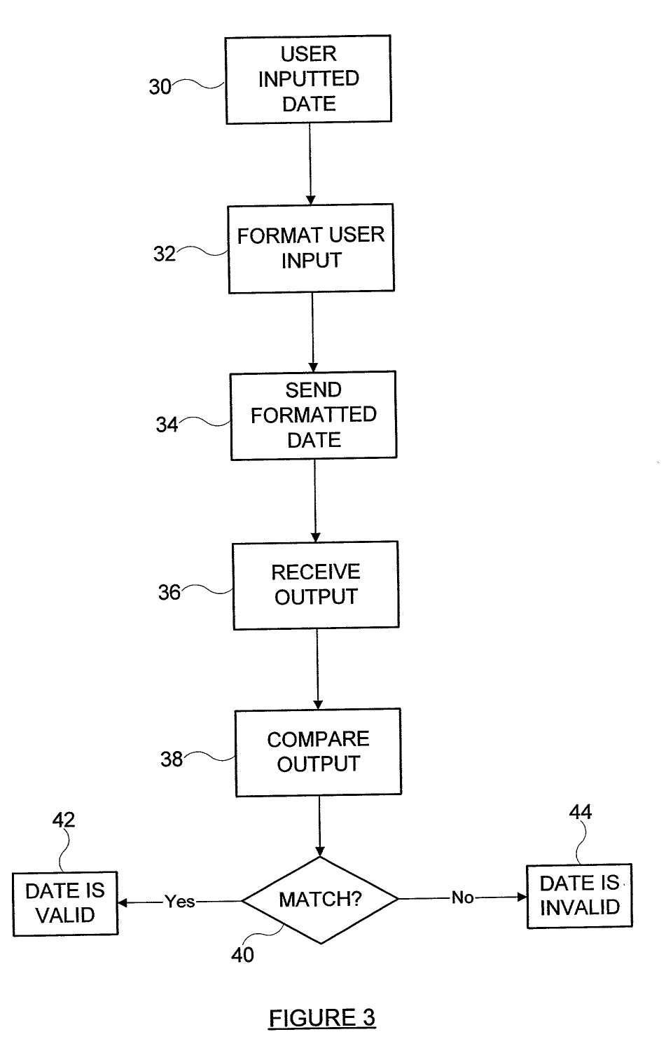

The present invention uses a function that resides in most commonly-used programming languages to determine the validity of the date. FIG. 3 illustrates an exemplary flow process of the date validation mechanism. The user inputs and submits the date (30) to a computer program. The computer program then formats the user input (32) to match requirements for the programming language format date function. In Java, for example, the format date function is called with the DateFormat class. Next, the computer program sends the formatted input to the programming language's format date function (34). The computer program then receives output from the format date function (36) and compares the output to the user-inputted date (38). A determination is made as to whether the user-inputted date and the received output from the format date function match (40). If they match, the user-inputted date is valid (42). If there is no match, the user-inputted date is invalid (44).

The following is an exemplary illustration of JavaScript software code that may used in the present invention:

// program start
function isValidDate (yearIn, monthIn, dayIn)
{

var yearOut, monthOut, dayOut, date;
var validDate=true, invalidDate=false;
// use the input to create a date
date = new Date (yearIn, monthIn, dateIn);
// get the value of year, month, and day from the date created
yearOut=date.getYear ( );
monthOut=date.getMonth ( );
dayOut=date.getDate ( );
// check if the two sets of values match
if ((yearIn==yearOut) && (monthIn==monthOut) &&
(dayIn==dayOut))

return validate; //date values are for a valid date

else return invalidate; // invalid input provided for date

} // program end

The date validation mechanism of the present invention may be implemented for a variety of different uses. For example the date validation mechanism may be implemented in computer programs that perform banking, video recording, document management, docketing, time management, e-mail, etc. Additionally, the date validation mechanism may be implemented in a variety of different computer systems, such as PC, Macintosh, UNIX, LINUX, mainframes, etc. The date validation mechanism may be implemented in equipment where the underlying programming language has a date creation function, such as desktop computers, laptop computers, PDA's, wireless phones, home appliances, programmable read-only memory units (i.e., microchips, processors, and firmware), set-top boxes, etc.

Advantages of the present invention may include one or more of the following. One advantage is that the date validation mechanism is able to be implemented on any device where the underlying programming language has a date creation function. Another advantage is that if the Gregorian calendar rules change, old programs do not need to be rewritten, merely recompiled as the date rules will be taken from the underlying programming language. A further advantage is that a programmer does not need to have an understanding of complex calendar rules and can rely upon the underlying programming language to determine the validity of a date. Another advantage is that the date validation mechanism is able to be performed on any tier within a multi-tiered architecture. A further advantage is that the date validation mechanism works on client-side, server-side, or middleware. Those skilled in the art can appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for validating a date, comprising:
formatting a user inputted date to match requirements of a programming language;
sending the formatted date as a parameter of a date format function of the programming language;
generating a program language generated date; and
comparing the user inputted date to the program language generated date.

2. The method of claim 1, further comprising:
transferring a formatted user inputted date to a program variable.

3. The method of claim 1, further comprising:
returning a Boolean value of true or false after comparing the output.

4. The method of claim 1, further comprising:
sending an object after the comparison.

5. The method of claim 1, further comprising:
throwing an exception after the comparison.

6. A method for validating a date, comprising:
formatting a user inputted date to match requirements of a programming language;
sending the formatted date as a parameter of a date format function of the programming language;
generating a program language generated date;
comparing the user inputted date to the program language generated date;
outputting the manipulated date input to a variable;
returning a Boolean value of true or false after comparing the output;
sending an object after the comparison; and
throwing an exception after the comparison.

7. A computer system to validate a date, comprising:
a processor;
a memory; and
software instructions stored in the memory for enabling the computer system under control of the processor, to perform:
formatting a user inputted date to match requirements of a programming language;
sending the formatted date as a parameter of a date format function of the programming language;
generating a program language generated date;
comparing the user inputted date to the program language generated date;
outputting the manipulated date input to a variable;
returning a Boolean value of true or false after comparing the output;
sending an object after the comparison; and
throwing an exception after the comparison.

8. A date validation mechanism, comprising:
means for formatting a user inputted date to match requirements of a programming language;
means for sending the formatted date as a parameter of a date format function of the programming language;
means for generating a program language generated date;
means for comparing the user inputted date to the program language generated date;
means for outputting the manipulated date input to a variable; and
means for returning a Boolean value of true or false after comparing the output.

9. The date validation mechanism of claim 8, further comprising:
means for sending an object after the comparison; and
means for selectively throwing an exception after the comparison.
